(19) United States
(12) Patent Application Publication
(10) Pub. No.: US 2003/0077481 A1
(43) Pub. Date: Apr. 24, 2003

(54) Soft complex magnet structure and method for manufacturing the soft complex magnet structure

(76) Inventors: Michael Wu, Taipei (TW); Chung-Kai Chen, Taipei (TW)

Correspondence Address: BRUCE H. TROXELL, SUITE 1404, 5205 LEESBURG PIKE, FALLS CHURCH, VA, 22041, US

(21) Appl. No.: 10/266,761

(22) Filed: Oct. 9, 2002

(30) Foreign Application Priority Data
Oct. 19, 2001 (TW) 90125849

(51) Int. Cl. B32B 9/00

(52) U.S. Cl. 428/693; 428/694 MM; 428/694 TM

(57) ABSTRACT

Soft complex magnet structure and method for manufacturing the soft complex magnet structure. The method includes steps of: providing a soft substrate; arranging positive and negative poles on at least one face of the soft substrate; and laying a magnetically attractable material layer on the other face of the soft substrate. By means of the magnetically attractable material layer, a magnetic conduction effect is provided for the soft substrate to increase the magnetic flux. Therefore, the magnet has stronger magnetic attraction and multiple magnets can be more firmly overlapped with each other.

### BACKGROUND OF THE INVENTION

The present invention is related to a soft complex magnet structure and method for manufacturing the soft complex magnet structure. The method includes steps of arranging positive and negative poles on one face of a soft substrate and laying a magnetically attractable material layer on the other face of the soft substrate. By means of the magnetically attractable material layer, a magnetic conduction effect is provided for the soft substrate to increase the magnetic field. Therefore, the magnet has stronger magnetic attraction and multiple magnets can be more firmly overlapped with each other.

A conventional soft magnet is generally used to press and fix a paper on a panel. An indicative picture or decorative picture can be formed on the soft magnet for exhibition. Referring to FIGS. 1 and 2, the soft magnet can be formed of multiple sheets with doll aspect (such as doll jigsaw puzzle). At least one face of the magnet sheet 1 is sequentially densely arranged with positive and negative poles 11, 12. In addition, a pre-designed plastic picture sheet 13 is attached to at least one face of the magnet sheet 1. Accordingly, many magnet sheets 1 with various patterns can be attached to each other as shown in FIG. 2. A magnet sheet 1 with a plastic picture sheet 13 of an alien body is overlapped with a magnet sheet 2 with a plastic picture sheet 23 of a clothes. Therefore, the magnet sheets can be intelligently assembled and attract and attach to each other to form a complete pattern.

Referring to FIGS. 2 and 3, the above magnet sheets 1, 2 still have some shortcomings as follows:

Both faces of the sheets 1, 2 are arranged with the positive and negative poles 11, 12, 21, 22. Therefore, when overlapping and attaching the sheets 1, 2 to each other, the positive pole 11 and negative pole 22 of the upper and lower sheets must be aligned with each other to make the sheets best attract each other. In the case that the magnetic poles are displaced, for example, the positive pole 11 of the sheet 1 is not aligned with the negative pole 22 of the sheet 2, the magnetic attraction will be weakened or even the sheets 1, 2 will repel each other. As a result, it will be impossible to correctly align the pictures 13, 23 of the upper and lower sheets 1, 2 with each other.

With respect to another type of magnet sheet, only one single face of the substrate has magnetism, while the other face has no magnetism. Therefore, the magnetic attraction between two sheets is weak. In the case that multiple sheets are overlapped, the magnetic force will be too weak to attach these sheets to each other. In order to overcome this problem, the sheets 1, 2 and 3 are more strongly magnetized. However, this will increase the manufacturing cost and difficulty in manufacturing.

### SUMMARY OF THE INVENTION

It is therefore a primary object of the present invention to provide a soft complex magnet structure and method for manufacturing the soft complex magnet structure. The soft complex magnets can be freely firmly attached to each other in any position. The method includes steps of sequentially arranging positive and negative poles on one face of a soft substrate and laying a magnetically attractable material layer on the other face of the soft substrate. The magnetically attractable material layer is a film made of powders of cast iron or reduced iron or nickel blended with plastic or rubber material by way of spraying, dripping, etc. By means of the magnetically attractable material layer, a magnetic conduction effect is provided for the soft substrate to increase the magnetic flux of the positive and negative poles of the substrate. Therefore, the magnet sheet has stronger magnetic attraction. The magnetically attractable material layer has no magnetic pole so that the adjacent magnet sheet can freely directly attracts the magnetically attractable material layer in any position. Multiple magnets can be more firmly overlapped with each other.

It is a further object of the present invention to provide the above soft complex magnet structure in which the magnetically attractable material layer has no magnetic pole so that the positive and negative poles of another magnet sheet can totally penetratively attract the magnetically attractable material layer. Therefore, when overlapping the magnet sheets, the decorative pictures disposed thereon can be easily aligned with each other without displacement or repelling.

The present invention can be best understood through the following description and accompanying drawings wherein:

### BRIEF DESCRIPTION OF THE DRAWINGS

FIG. 1 is a perspective exploded view of a conventional magnet sheet;

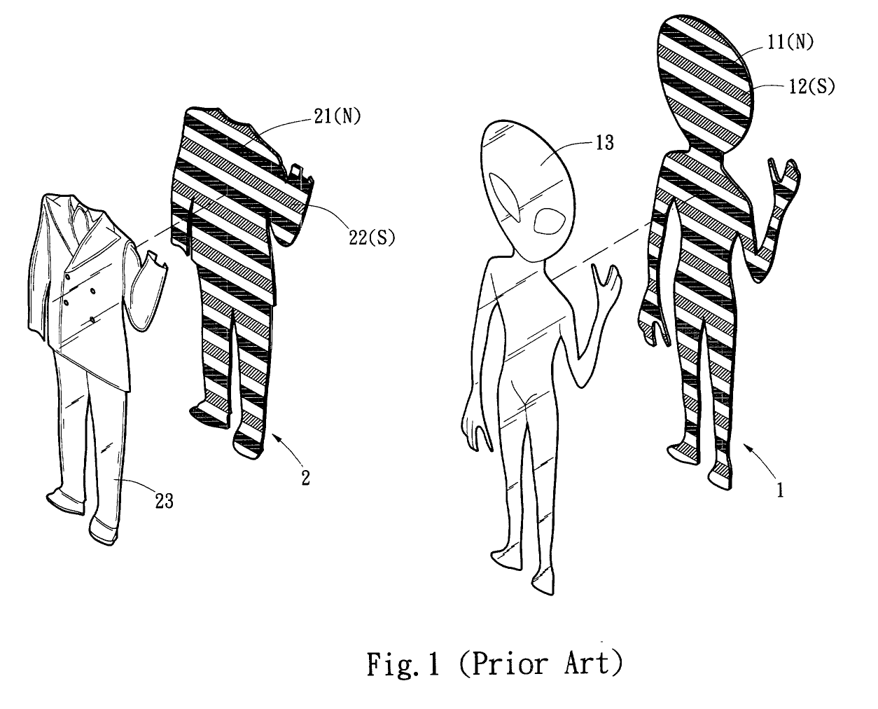

FIG. 2 is a perspective assembled view of the conventional magnet sheet;

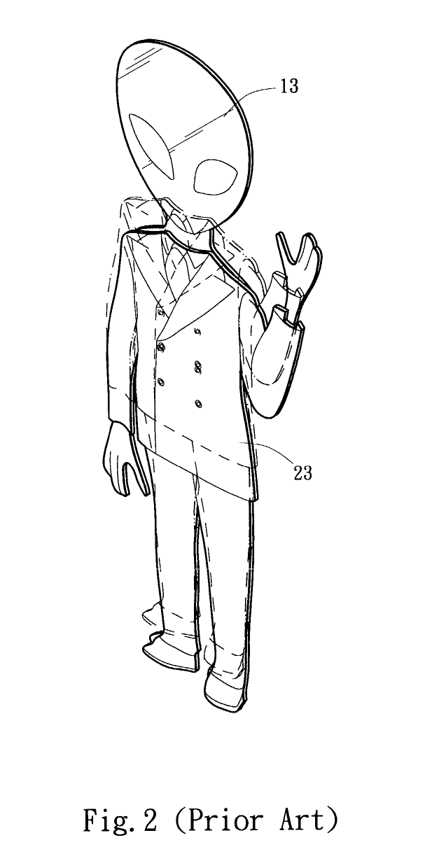

FIG. 3 is a sectional view of the conventional magnet sheet;

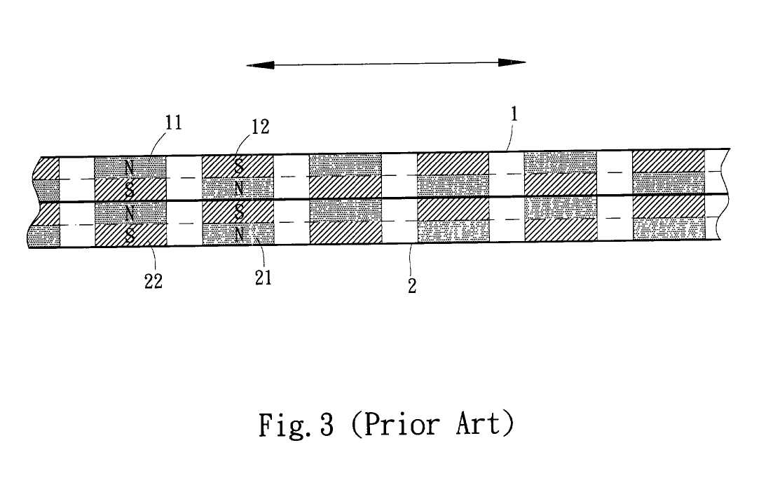

FIG. 4 is a perspective exploded view of the present invention;

FIG. 5 is a perspective view showing the application of the present invention; and

FIG. 6 is a perspective assembled view according to FIG. 5.

### DETAILED DESCRIPTION OF THE PREFERRED EMBODIMENTS

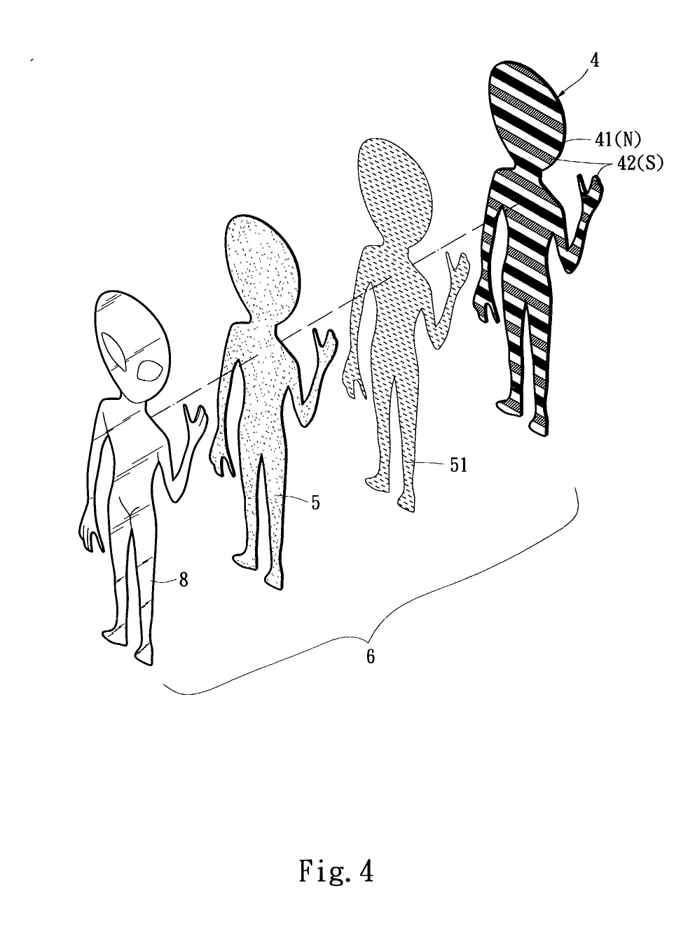

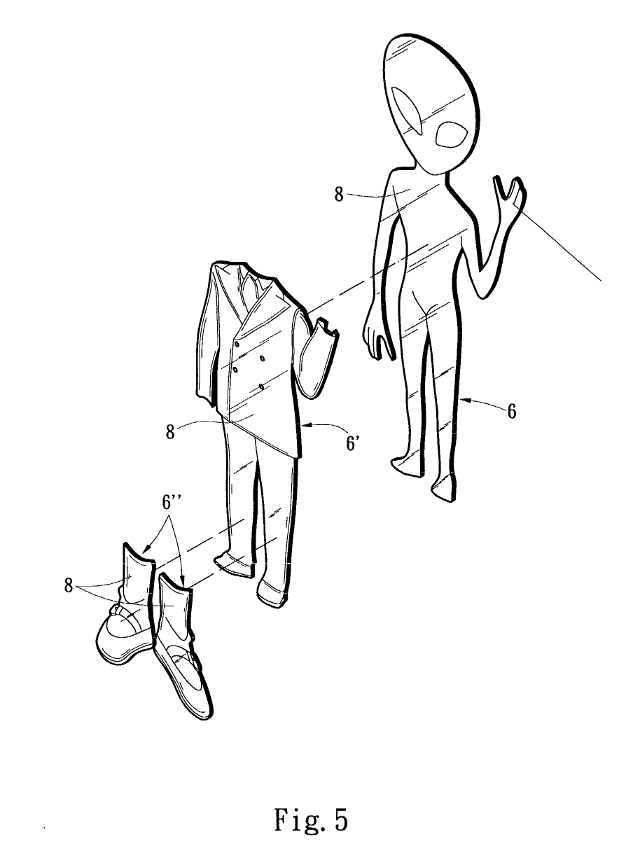

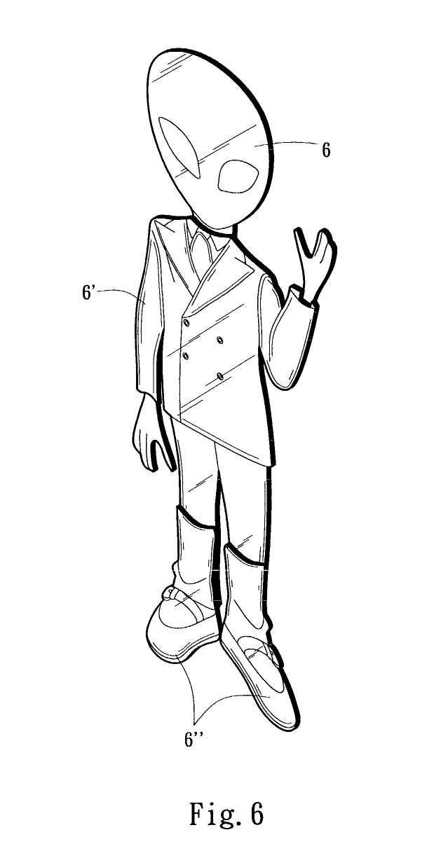

Please refer to FIGS. 4 to 6. The manufacturing method of the present invention includes the following steps: A soft substrate 4 which can be magnetized is previously prepared. The soft substrate 4 can be made of plastic or rubber material blended with magnetic material. The magnetic material can be powders of barium, strontium, rubidium, cobalt or boron (isotropic or anisotropic). Then the soft substrate is sequentially arranged with positive and negative poles 41, 42. Then, a magnetically attractable material layer 5 is laid on one side of the soft substrate 4 to form a magnet sheet 6. The magnetically attractable material layer 5 can be connected with the soft substrate 4 in such a manner that via an adhesive 51, the substrate 4 and the magnetically attractable material layer 5 are complexly rolled and pressed. Alternatively, the magnetically attractable material layer 5 can be sprayed or dript onto the substrate 4 or directly integrally molded with the substrate 4. The magnetically attractable material layer 5 can be formed of film or sheet made of powders of cast iron, reduced iron, etc. blended with plastic or rubber material.

Accordingly, by means of the distinction between the magnetically attractable material layer 5 and the magnetic poles, the magnetic poles 421, 422 of the magnet sheets are not limited in attraction position. Therefore, they can freely attract and attach to each other in any position. Accordingly, the repelling between the identical poles can be avoided so that the magnet sheets can firmly attach to each other. The magnet sheets will not slip and displace from each other. In addition, a magnetic conduction effect is provided for the substrate 4 to create stronger magnetic field. Therefore, the magnet sheet 6 can have stronger magnetic attraction. When overlapping the magnet sheets 6, 6′, 6″, the substrates 4 thereof are magnetically conducted by the magnetically attractable material layer 5 so that the magnetic attraction is strengthened and the magnet sheets can more firmly attach to each other.

Referring to FIGS. 4, 5 and 6, a plastic picture sheet 8 can be further attached to the magnetically attractable material layer 5 by way of thermal fusion or adhesion or integrally molded with the magnetically attractable material layer 5 to achieve an entertaining effect.

According to the above arrangement, the soft magnet sheets can be freely attached to each other in any position. The above embodiments are only used to illustrate the present invention, not intended to limit the scope thereof. Many modifications of the above embodiments can be made without departing from the spirit of the present invention.

What is claimed is:

1. Method for manufacturing soft complex magnet, comprising steps of:
previously providing a soft substrate which can be magnetized;
arranging positive and negative poles on at least one side of the soft substrate; and
connecting a magnetically attractable material layer on the other side of the soft substrate.

2. Method for manufacturing soft complex magnet, comprising steps of:
previously providing a soft substrate which can be magnetized;
connecting a magnetically attractable material layer on one side of the soft substrate; and
arranging positive and negative poles on the other side of the soft substrate.

3. Method for manufacturing soft complex magnet as claimed in claim 1, wherein the magnetically attractable material layer is attached to and connected with the soft substrate by way of adhesion.

4. Method for manufacturing soft complex magnet as claimed in claim 2, wherein the magnetically attractable material layer is attached to and connected with the soft substrate by way of adhesion.

5. Method for manufacturing soft complex magnet as claimed in claim 1, wherein the magnetically attractable material layer is attached to and connected with the soft substrate by means of spraying the magnetically attractable material onto one face of the soft substrate.

6. Method for manufacturing soft complex magnet as claimed in claim 2, wherein the magnetically attractable material layer is attached to and connected with the soft substrate by means of spraying the magnetically attractable material onto one face of the soft substrate.

7. Method for manufacturing soft complex magnet as claimed in claim 1, wherein the magnetically attractable material layer is attached to and connected with the soft substrate by means of dripping the magnetically attractable material onto one face of the soft substrate.

8. Method for manufacturing soft complex magnet as claimed in claim 2, wherein the magnetically attractable material layer is attached to and connected with the soft substrate by means of dripping the magnetically attractable material onto one face of the soft substrate.

9. Method for manufacturing soft complex magnet as claimed in claim 1, wherein the magnetically attractable material layer is attached to and connected with the soft substrate by means of adhesion and rolling and pressing.

10. Method for manufacturing soft complex magnet as claimed in claim 2, wherein the magnetically attractable material layer is attached to and connected with the soft substrate by means of adhesion and rolling and pressing.

11. Method for manufacturing soft complex magnet as claimed in claim 1, wherein the magnetically attractable material layer is attached to and connected with the soft substrate by means of integral molding.

12. Method for manufacturing soft complex magnet as claimed in claim 2, wherein the magnetically attractable material layer is attached to and connected with the soft substrate by means of integral molding.

13. Soft complex magnet structure comprising a soft substrate which can be magnetized and a magnetically attractable material layer which is connected on one side of the soft substrate, positive and negative poles being arranged on the other side of the soft substrate.

14. Soft complex magnet structure as claimed in claim 13, wherein the soft substrate is a sheet made of plastic or rubber material blended with magnetic material, the soft substrate being then magnetized.

15. Soft complex magnet structure as claimed in claim 14, wherein the magnetic material can be barium, strontium, rubidium, cobalt or boron or compound thereof.

16. Soft complex magnet structure as claimed in claim 13, wherein a decorative picture is disposed on outer surface of the magnetically attractable material layer.

17. Soft complex magnet structure as claimed in claim 14, wherein a decorative picture is disposed on outer surface of the magnetically attractable material layer.

18. Soft complex magnet structure as claimed in claim 15, wherein a decorative picture is disposed on outer surface of the magnetically attractable material layer.

19. Soft complex magnet structure as claimed in claim 16, wherein the decorative picture is connected with the magnetically attractable material layer by means of an adhesive.

20. Soft complex magnet structure as claimed in claim 17, wherein the decorative picture is connected with the magnetically attractable material layer by means of an adhesive.

21. Soft complex magnet structure as claimed in claim 18, wherein the decorative picture is connected with the magnetically attractable material layer by means of an adhesive.

22. Soft complex magnet structure as claimed in claim 12, wherein the magnetically attractable material layer is made of cast iron or reduced iron blended with plastic or rubber material.

23. Soft complex magnet structure as claimed in claim 13, wherein the magnetically attractable material layer is made of cast iron or reduced iron blended with plastic or rubber material.

24. Soft complex magnet structure as claimed in claim 14, wherein the magnetically attractable material layer is made of cast iron or reduced iron blended with plastic or rubber material.

25. Soft complex magnet structure as claimed in claim 22, wherein the decorative picture is connected with the magnetically attractable material layer by means of an adhesive.

26. Soft complex magnet structure as claimed in claim 23, wherein the decorative picture is connected with the magnetically attractable material layer by means of an adhesive.

27. Soft complex magnet structure as claimed in claim 24, wherein the decorative picture is connected with the magnetically attractable material layer by means of an adhesive.

28. Soft complex magnet structure as claimed in claim 13, wherein the magnetically attractable material layer is attached to and connected with the soft substrate by way of adhesion.

29. Soft complex magnet structure as claimed in claim 14, wherein the magnetically attractable material layer is attached to and connected with the soft substrate by way of adhesion.

30. Soft complex magnet structure as claimed in claim 15, wherein the magnetically attractable material layer is attached to and connected with the soft substrate by way of adhesion.

31. Soft complex magnet structure as claimed in claim 13, wherein the magnetically attractable material layer is attached to and connected with the soft substrate by means of spraying the magnetically attractable material onto one face of the soft substrate.

32. Soft complex magnet structure as claimed in claim 14, wherein the magnetically attractable material layer is attached to and connected with the soft substrate by means of spraying the magnetically attractable material onto one face of the soft substrate.

33. Soft complex magnet structure as claimed in claim 15, wherein the magnetically attractable material layer is attached to and connected with the soft substrate by means of spraying the magnetically attractable material onto one face of the soft substrate.

34. Soft complex magnet structure as claimed in claim 13, wherein the magnetically attractable material layer is attached to and connected with the soft substrate by means of dripping the magnetically attractable material onto one face of the soft substrate.

35. Soft complex magnet structure as claimed in claim 14, wherein the magnetically attractable material layer is attached to and connected with the soft substrate by means of dripping the magnetically attractable material onto one face of the soft substrate.

36. Soft complex magnet structure as claimed in claim 15, wherein the magnetically attractable material layer is attached to and connected with the soft substrate by means of dripping the magnetically attractable material onto one face of the soft substrate.

37. Soft complex magnet structure as claimed in claim 13, wherein the magnetically attractable material layer is attached to and connected with the soft substrate by means of adhesion and rolling and pressing.

38. Soft complex magnet structure as claimed in claim 14, wherein the magnetically attractable material layer is attached to and connected with the soft substrate by means of adhesion and rolling and pressing.

39. Soft complex magnet structure as claimed in claim 15, wherein the magnetically attractable material layer is attached to and connected with the soft substrate by means of adhesion and rolling and pressing.
